(19) United States
(12) Patent Application Publication
(10) Pub. No.: US 2019/0173938 A1
(43) Pub. Date: Jun. 6, 2019

(54) A METHOD OF AUTHORISING AN AUDIO DOWNLOAD

(71) Applicant: POWERCHORD GROUP LIMITED, London (GB)

(72) Inventor: Graham TULL, Guildford, Surrey (GB)

(21) Appl. No.: 16/324,498

(22) PCT Filed: Aug. 8, 2017
(86) PCT No.: PCT/GB2017/052331

§ 371 Date: Feb. 8, 2019

(30) Foreign Application Priority Data
Aug. 8, 2016 (GB) 1613587.3

(51) Int. Cl. H04L 29/08; H04W 4/06; G06F 21/44; H04W 12/06; H04L 29/06

(52) U.S. Cl. CPC H04L 67/06; H04W 4/06; H04L 63/0876; H04W 12/06; H04L 63/0892; G06F 21/44

(57) ABSTRACT

A method of authorising an audio download is provided. The method comprises: receiving, at a receiving device, a first wireless signal comprising authorisation data; requesting an audio download using the authorisation data; receiving a transmission comprising the audio download. An audio download system and an audio broadcast system are also provided.

### TECHNICAL FIELD

The present disclosure relates to a method of authorising an audio download and is particularly, although not exclusively, concerned with a method of authorising an audio download by transferring authorisation data to an audio downloading device.

### BACKGROUND

Attendees at an event, such as a music concert, may use a personal audio receiver to receive a wirelessly transmitted signal comprising a high quality recording of sound, such as music, being produced by performers at the event. The attendees may listen to the high quality recording of the sound using the personal audio receiver in substantial time synchronisation with sound being received acoustically from the stage or from speakers provided at the event venue. Listening to the sound of the performance in this way may enhance the listening experience for the attendees.

After the event, attendees may wish to download a recorded version of the performance to experience at a future time.

### STATEMENTS OF INVENTION

According to an aspect of the present disclosure, there is provided a method of authorising an audio download, the method comprising: receiving, at a receiving device, a first wireless signal comprising authorisation data; requesting an audio download using the authorisation data; and receiving a transmission comprising the audio download.

According to an aspect of the present disclosure, there is provided a method of receiving an audio download, the method comprising: receiving, at a receiving device, a first wireless signal comprising authorisation data; requesting an audio download using the authorisation data; and receiving a transmission comprising the audio download.

The audio download may comprise one or more downloaded audio channels.

The first wireless signal may further comprise one or more audio channels. Additionally or alternatively, the method may further comprise receiving a second wireless signal comprising one or more audio channels. The audio download may correspond to one or more of the audio channels.

According to another aspect of the present disclosure, there is provided a method of authorising an audio download, the method comprising: receiving, at a receiver, a first wireless signal comprising one or more audio channels; requesting an audio download, wherein the audio download corresponds to one or more of the audio channels; and receiving a transmission comprising the audio download.

According to another aspect of the present disclosure, there is provided a method of receiving an audio download, the method comprising: receiving, at a receiver, a first wireless signal comprising one or more audio channels; requesting an audio download, wherein the audio download corresponds to one or more of the audio channels; and receiving a transmission comprising the audio download.

The receiver may be an audio receiver device. Alternatively, the receiver may be a user interface device, such as a mobile telephone or portable computing device.

The first wireless signal may further comprise authorisation data. Additionally or alternatively, the method may further comprise receiving a second wireless signal comprising authorisation data. The audio download may be requested using the authorisation data.

The transmission comprising the audio download may further comprise an associated download. The associated download may comprise additional content, e.g. media, associated with the audio download. For example, the additional, associated download may be an image or video clip relating to a performer and/or a performance. The associated download received may correspond to the authorisation data. In other words, download of the associated download may be authorised by the authorisation data.

The first and second wireless signals may be transmitted within substantially the same area or range. The first and second wireless signals may be received at substantially the same location, e.g. when the receiver is located at substantially the same location. The first and second wireless signals may be received at substantially the same time.

The method may further comprise transmitting the first wireless signal using a first transmitter. The first transmitter may be located away from the receiving device, e.g. the first transmitter may be remote from the receiving device. The first wireless signal may be transmitted over an area, e.g. within a range of the transmitter, within which sound corresponding to the audio download is audible.

The method may further comprise transmitting the second wireless signal using a second transmitter. The second transmitter may be located away from the receiving device, e.g. remote from the receiving device. The second transmitter may be located close, e.g. adjacent, to the first transmitter. The second wireless signal may be transmitted over an area within which sound corresponding to one or more of the audio channels is audible. Additionally or alternatively, the second wireless signal may be transmitted using the first transmitter. In some arrangements, the first and second wireless signals may be combined within a combined wireless signal transmitted by the first and/or second transmitter.

The first and/or second wireless signals may be transmitted over an area within which sound corresponding to one or more of the audio channels is audible.

The method may comprise coupling the receiving device to an audio downloading device. The transmission comprising the audio download may be received by the audio downloading device.

The method may comprise receiving at the receiving device and/or audio downloading device a user content setting. The method may further comprise adjusting the relative volumes of one or more of the audio channels according to the user content setting.

The method may comprise storing the user content setting on the receiving device and/or audio downloading device. For example, the user content setting may be stored on the audio download device and may be associated with the authorisation data, e.g. the authorisation data relating to an audio download comprising downloaded audio channels corresponding to the audio channels, or the audio download comprising the corresponding downloaded audio channels.

The method may comprise transferring the authorisation data from the receiving device to the audio downloading device. The audio download may be requested by the audio downloading device using the authorisation data.

The method may comprising transmitting one or more of the downloaded audio channels using the audio download device.

The method may comprise receiving the downloaded audio channels transmitted by the audio downloading device at the receiving device. The method may further comprise playing back one or more of the downloaded audio channels using a first audio transducer associated with the receiving device.

The method may comprise playing back one or more of the downloaded audio channels from the audio download using a second audio transducer associated with the audio downloading device.

The method may comprise receiving at the receiving device and/or audio downloading device a user content setting. The method may further comprise adjusting the relative volumes of one or more of the downloaded audio channels from the audio download according to the user content setting. For example, the relative volumes of the downloaded audio channels may be adjusted at the audio downloading device prior to transmitting the downloaded audio channels or playing back the downloaded audio channels. The relative volumes of one or more of the downloaded audio channels from the audio download may be adjusted according to the stored user content setting.

The method may further comprise combining one or more of the audio channels into a combined audio channel. Alternatively, one or more of the downloaded audio channels may be combined into the combined audio channel. The combined audio channel may be transmitted and/or played back by the audio downloading device, e.g. using a second audio transducer associated with the audio downloading device.

The first wireless signal may be a unidirectional broadcast signal. Additionally or alternatively, the second wireless signal may be a unidirectional broadcast signal.

According to another aspect of the present disclosure, there is provided a method of operating an audio system, the method comprising: receiving a wireless signal at a receiver, the wireless signal comprising one or more audio channels; requesting a download of audio data, wherein the audio data corresponds to one or more of the audio channels; receiving a transmission comprising the audio data.

The method may comprise storing the audio data in a memory associated with the audio system.

The method may comprise playing back one or more of the audio channels using an audio playback device. The audio channels may be played back substantially at the same time as the wireless signal is being received.

The method may comprise receiving authorisation data. The download may be requested using the authorisation data. The authorisation data may be received at substantially the same time as the one or more audio channels, e.g. within the same transmissions.

According to another aspect of the present disclosure, there is provided an audio system comprising: a receiver configured to receive a wireless signal comprising authorisation data; and a downloader configured to: request a download comprising audio data, wherein the download is requested using the authorisation data, and receive the download.

The wireless signal may further comprise one or more audio channels. The audio data may correspond to one or more of the audio channels.

The receiver may be configured to receive a further wireless signal comprising one or more audio channels. The audio data may correspond to one or more of the audio channels.

The receiver may be further configured to playback one or more of the audio channels using a first audio transducer associated with the receiver. One or more of the audio channels may be played back following a delay after the wireless signal has been received by the receiver.

The receiver and/or the downloader may be configured to receive a user content setting. The receiver and/or the downloader may be configured to adjust the relative volumes of one or more of the audio channels according to the user content setting. The user content setting may be received directly at the receiver, e.g. from the user input device. Alternatively, the user content setting may be received from the downloader or a separate user interface device and may be transmitted to the receiver.

The downloader may be further configured to playback one or more of the audio channels provided within the audio data using a second audio transducer associated with the downloader.

The downloader may be further configured to broadcast a further wireless signal comprising one or more of the downloaded audio channels provided within the audio data.

The downloader may be configured to receive a user setting. The downloaded may be further configured to adjust the relative volumes of one or more of the audio channels according to the user setting.

According to another aspect of the present disclosure, there is provided an audio broadcast system configured to broadcast an audio signal within a venue, the system comprising a first transmitter configured to broadcast the audio signal within the venue. The audio broadcast system may be further configured to broadcast authorisation data relating to an audio download corresponding to the audio signal. For example, the system may comprise a second transmitter configured to transmit the authorisation data. Alternatively, the audio broadcast system may comprise a multiplexer configured to combine the authorisation data with the audio signal. The combined audio signal and authorisation data may be broadcast by the first transmitter. According to another aspect of the present disclosure, there is provided an audio broadcast system configured to broadcast an audio signal within a venue, the system comprising: a digital audio work station configured to combine one or more digital audio signals to generate two or more audio mixes; a multiplexer configured to generate a multiplexed signal comprising the two or more audio mixes; and a first transmitter configured to broadcast the multiplexed signal within the venue.

According to another aspect of the present disclosure, there is provided an audio broadcast system configured to broadcast an audio signal within a venue, the system comprising: an audio distribution box configured to receive a plurality of audio input channels and distribute the audio input channels to a stage audio mixer and a plurality of Analogue to Digital Convertors (ADCs) and/or preamplifiers; the plurality of ADCs and/or preamplifiers being configured to generate a plurality of digital audio signals based on the audio channel inputs; a digital audio work station configured to combine one or more of the digital audio signals to generate two or more audio mixes; a multiplexer configured to generate a multiplexed signal comprising the two or more audio mixes; and a first transmitter configured to broadcast the multiplexed signal within the venue.

The audio broadcast system may be further configured to broadcast authorisation data relating to an audio download corresponding to one or more of the audio input channels, digital audio signals and/or audio mixes. The broadcast authorisation data may enable an attendee within the venue to download an audio download comprising audio corresponding to at least a portion of one or more of the audio input channels, digital audio signals and/or audio mixes, and/or an associated download. The authorisation data may be generated by the digital audio workstation or another controller of the audio broadcast system.

The system may further comprise the stage audio mixer. The stage audio mixer may be configured to combine one or more of the audio input channels to create a first audio mix. The audio distribution box may receive the first audio mix and may distribute the first audio mix to the ADCs.

The multiplexer may be configured to generate metadata based on the first audio mix. The multiplexer may be configured to generate the multiplexed audio signal comprising the two or more audio mixes and the metadata. Additionally or alternatively, the multiplexer may be configured to combine the authorisation data with the audio mixes within the multiplexed signal.

The system may further comprise a speaker. The speaker may be configured to project the first mix within the venue as an acoustic audio signal.

The digital audio workstation may comprise a time source. The transmission of audio signals between the plurality of ADCs and/or preamplifiers, the digital audio work station and the multiplexer may be synchronised according to the time source.

The multiplexer may be configured to generate a timing signal according to the time source. The multiplexer may be configured to provide the timing signal to the first transmitter. Timing of a transmission of audio signals between the multiplexer and the transmitter may be performed according to the timing signal. Additionally or alternatively, timing of a transmission of wireless signals by the transmitter may be performed according to the timing signal.

The system may further comprise a second transmitter. The second transmitter may be coupled to the first transmitter or the multiplexor and may be configured to broadcast the multiplexed signal within the venue. Additionally or alternatively, the second transmitter may be configured to broadcast the authorisation data.

The first transmitter, or the multiplexer may be configured to provide the timing signal to the second transmitter. The timing of a transmission of wireless signals by the second transmitter may be performed according to the timing signal. In this way, the transmission of the multiplexed signal by the first and second transmitter may be synchronised according to the time source.

The multiplexer may be configured to receive authorisation data corresponding to one or more of the audio mixes. The multiplexed signal generated by the multiplexer may comprise the authorisation data.

The transmitter may be configured to provide diagnostic information relating to the operation of the transmitter to the multiplexer.

The timing signal from the digital audio workstation may transmitted using an optical connection, such as an Electrical Industries Association of Japan (EIAJ) optical connection. The multiplexer may be configured to encode the further mixes using an audio compression algorithm before the multiplexed signal is generated, wherein the multiplexed signal comprises the encoded further mixes.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1a is a schematic view of a system for presenting media to a plurality of attendees at an event;

FIG. 1b is a schematic view of the stage equipment, audio broadcast equipment and audio projection equipment of the system for presenting media;

FIG. 2 is a schematic view of an apparatus for presenting media;

FIG. 3 shows a method of presenting media:

FIG. 4 shows a method of synchronising an audio signal;

FIG. 5 shows a method of synchronising an audio signal;

FIG. 6 shows a method of downloading an audio content; and

FIG. 7 is a schematic view of a system for downloading an audio content.

### DETAILED DESCRIPTION

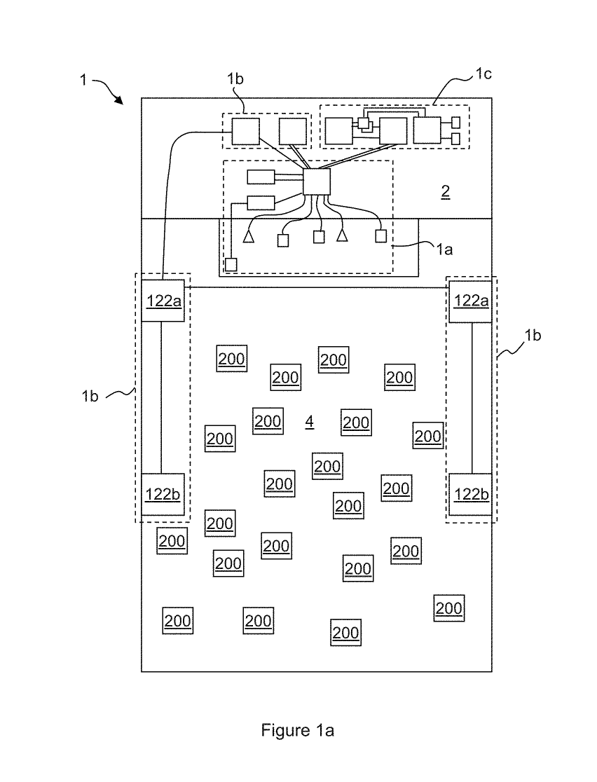

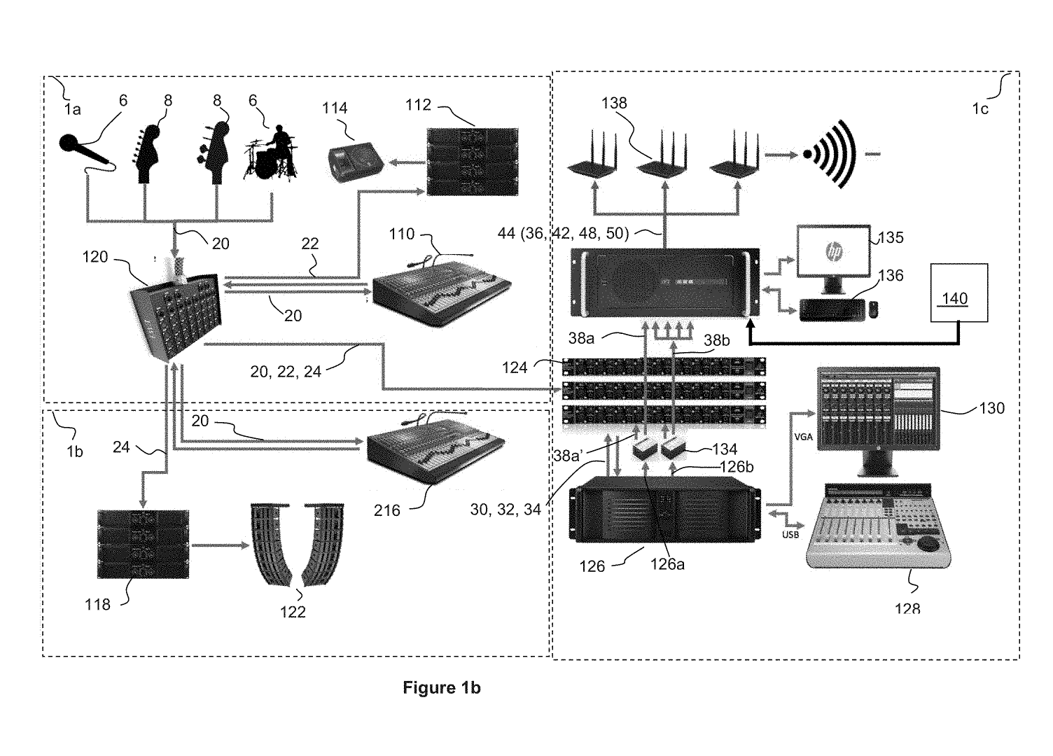

With reference to FIG. 1a, a venue for a concert or other live event comprises a performance area, such as a stage 2, and an audience area 4. The audience area may comprise one or more stands of seating in a venue such as a theatre or arena. Alternatively, the audience area may be a portion of a larger area such as a park, within which it is desirable to see and/or hear a performance on the stage 2. In some cases, the audience area 4 may be variable, being defined by the crowd of people gathered for the performance.

A media system 1 may be provided within the venue to capture the sound produced by performers on the stage 2, process the sound and project the processed sound into the audience area 4, such that attendees at the event are able to hear the performance.

With reference to FIGS. 1a and 1b, the media system 1 comprises stage audio equipment 1a, configured to record sounds being produced by performers on the stage; sound projection equipment 1b, configured to process the sound from the performers and project the sound throughout the venue; and sound broadcast equipment 1c, configured to broadcast a wireless signal comprising a high quality recording of the sound from the performers throughout the venue.

As depicted in FIG. 1a, the media system 1 may further comprise a plurality of personal audio receivers 200. Some or each of the attendees at the event may use the personal audio receivers 200 to receive the wireless signal from the sound broadcast equipment 1c and reproduce the high quality recording of the sound. The attendees may listen to the high quality recording in substantial time synchronisation with the acoustic sound being projected throughout the venue by the sound projection equipment 1b.

The stage audio equipment 1a may comprise one or more microphones 6 and/or one or more instrument pick-ups 8. The sound produced by instrumentalists and vocalists performing on the stage 2 is picked up by the microphones 6 and/or the instrument pick-ups 8 and converted into a plurality of input audio channels 20 that are provided to the sound projection equipment 1b and the sound broadcast equipment 1c.

The stage audio equipment 1a may further comprise a stage audio distribution box 120 configured to receive the input audio channels 20 from the microphones 6 and instrument pick-ups 8. The stage audio distribution box 120 may be configured to split the input audio channels 20 to enable the input audio channels to be delivered to the audio projection equipment 1b and to the audio broadcast equipment 1c. The inputs received by the audio projection equipment 1b and the audio broadcast equipment 1c may be substantially the same as each other and may be substantially the same as the audio signals 20 from the stage audio equipment 1c.

The input audio channels 20 received from the microphones 6 and instrument pick-ups 8 may be analogue signals and hence, the stage audio distribution box 120 may be an analogue device.

As shown in FIG. 1b, the stage audio distribution box 120 may be communicatively coupled to a monitor mixer 110. The monitor mixer 110 may be configured to adjust the relative volumes of the input audio channels 20 and combine the adjusted input audio channels to generate a monitor mix 22 to be projected onto the stage 2 and be heard by the performers on the stage. The relative volumes and equalisation of the input audio channels 20 in the monitor mix may be set according to the performers' preferences.

In some arrangements, a single monitor mix 22 may be generated and may be heard by all the performers on the stage. However, in other arrangements, two or more monitor mixes may be generated and each of the performers and/or one or more groups of the performers may listen to the different monitor mixes.

As shown in FIG. 1b, the monitor mixes 22 generated by the monitor mixers 110 may be returned to the stage audio distribution box 120 to be distributed to other components of the media system 1, as described below.

The stage audio equipment 1a may further comprise one or more monitor amplifiers 112 configured to amplify the monitor mix 22, and one or more stage monitors 114 configured to project the amplified monitor mix to the performers on the stage. As depicted in FIG. 1b, the monitor amplifiers 112 may be communicatively coupled to the stage audio distribution box 120 and may receive the monitor mix 22 from the monitor mixer 110 via the stage distribution box. Alternatively, the monitor amplifier 112 may be coupled to the monitor mixer 110 and may receive the monitor mix from, e.g. directly from, the monitor mixer 110.

As depicted in FIG. 1b, the audio projection equipment 1b may comprise a main mixer 116. The main mixer 116 may be communicatively coupled to the stage audio distribution box 120 and may be configured to adjust the relative volumes of one, more than one or each of the input audio channels 20 and combine the adjusted input audio channels to generate a main mix 24, to be projected into the audience area by the audio projection equipment 1b. The relative volumes of the input audio channels may be adjusted according to a main mix setting. The main mix setting may be set by an audio technician prior to and/or during the performance. The relative volumes may be selected to provide what the audio technician considers to be the best mix of instrumental and vocal sounds to be projected throughout the venue. In some cases performers may request that the mix is adjusted according to their own preferences.

The main mixer 116 may be configured to adjust the equalisation of the main mix 24, for example, to increase or decrease the volume of certain frequency ranges within the main mix audio signal 24 according to an equalisation setting. The equalisation setting may be similarly selected by the audio technician and/or performers according to their personal tastes and may be at least partially selected according to the acoustic environment of the venue and/or the nature of the performance.

The main mix 24 may be returned from the main mixer 116 to the stage audio distribution box 120 to be distributed to other components of the audio system 1, as described below.

The audio projection equipment 1b may comprise one or more main amplifiers 118 configured to amplify the main mix 24 and one or more speakers 122 configured to project the main mix 24 into the audience area 4. As shown in FIG. 1b, the main amplifiers 118 may be coupled to the stage audio distribution box 120 and may receive the main mix from the stage audio distribution box 120. Alternatively, the main amplifier 118 may be coupled to the main mixer 116 and may receive the main mix 24 from, e.g. directly from, the main mixer 116.

In the arrangement shown in FIG. 1b, the audio projection equipment 1b comprises two speakers, however, it is envisaged that any number of speakers 122 may be provided within the audio projection equipment. As depicted in FIG. 1a, the speakers may comprise front speakers 122a and additional speakers 122b. The front speakers 122a may be provided at the front of the audience area 4 and the additional speakers 122b may be provided within the audience area 4 and may be configured to project the main mix 24 to attendees located towards the back of the audience area 4.

Sound from the front speakers 122a reaches audience members towards the back of the audience area 4 a short period of time after the sound from the additional speakers 122b. In large venues, this delay may be detectable by the audience members and may lead to echoing or reverb type effects. In order to avoid such effects, the audio signal provided to the additional speakers 122b is delayed before being projected into the audience area 4. The signal may be delayed by the additional speakers 122b, the main amplifier 118, or any other component or device within the audio system 1.

Sound from the front speakers 122a and the additional speakers 122b will therefore reach an attendee towards the rear of the audience area 4 at substantially the same time, such that no reverb or echoing is noticeable.

Owing to the mixed and equalised sounds being reproduced by multiple speaker systems throughout the venue, some of which are configured to delay the signal before reproducing the sound, interference may occur between the projected sounds waves in certain areas of the venue, which deteriorates the quality of audible sound. For example, certain instruments and/or vocalists may become indistinguishable, not clearly audible or substantially inaudible within the overall sound. In addition to this, the acoustic qualities of the venue may vary according to the location within the venue and hence the equalisation of the sound may be disrupted for some audience members. For example, the bass notes may become overly emphasised.

As described above, the mix and equalisation of the sound from the performance may be set according to the personal tastes of the audio technician and/or the performers. However, the personal tastes of the individual audience members may vary from this and may vary between the audience members. For example a certain audience member may prefer a sound in which the treble notes are emphasised more than in the sound being projected from the speakers 122, whereas another audience member may be particularly interested in hearing the vocals of a song being performed and may prefer a mix in which the vocals are more distinctly audible over the sounds of other instruments.

By providing the sound broadcast equipment 1c and the personal audio receivers 200, as described in detail below, within the media system 1, each audience member may be able to experience an improved quality and consistency of audio and may be able to adjust the mix and equalisation of the audio individually.

As shown in FIG. 1b, the stage audio distribution box 120 may provide the input audio channels 20 to the audio broadcast equipment 1c. As described above, the stage audio distribution box 120 may also receive the monitor mixes 22 and the main mix 24 generated by the monitor mixer 110 and main mixer 116 respectively. The stage audio distribution box 120 may be configured to provide the main mix 24 and one or more monitor mixes 22 to the audio broadcast equipment 200c in addition, or as an alternative, to providing the input audio channels 20.

The audio broadcast equipment 1c may comprise one or more analogue to digital convertors (ADCs) 124. The ADCs may be configured to receive the audio signals 20, 22, 24 provided by the stage audio distribution box. As mentioned above, the stage audio distribution box 120 may be an analogue device and the audio signals input to the audio broadcast equipment 1c from the stage audio distribution box 120 may be analogue audio signals. The ADCs 120 may be configured to convert the analogue audio signals into digital input audio channels 30 and/or digital audio mix channels 32, 34 to be processed by the audio broadcast equipment 1c as described below.

In the arrangement shown in FIG. 1b, the ADCs 124 are combined ADC and pre-amplifiers, however, in other arrangements (not shown), the audio broadcast equipment 1c may comprise one or more separate pre-amplifiers. The pre-amplifiers may be arranged before and/or after the ADCs. In other words, the pre amplifiers may be configured to amplify the audio signals before and/or after they have been converted from analogue signals to digital signals.

The ADCs may output the digital audio channels 30, 32, 34 corresponding to the input audio channels 20, monitor mixes 22 and/or main mix 24 to a digital audio workstation 126. The ADCs may be coupled to the digital audio workstation 126 via an optical connection such as a TOSlink® connection.

In other arrangements of the disclosure, the stage audio equipment 1a may comprise analogue to digital convertors configured to convert the input audio channels 20 to digital signals. The stage audio equipment 1a may thereby provide digital audio channels directly to the digital audio workstation 126 or the pre-amplifiers.

The digital audio workstation 126 may be configured to process the digital audio channels 30, 32, 34 to generate one or more broadcast mixes 36 to be broadcast by the audio broadcast equipment 1c. In particular, the digital audio workstation 126 may be configured to adjust the relative volumes of one, several or each of the digital audio channels 30, 32, 34 and may combine the adjusted digital audio channels to generate the broadcast mixes 36. Each of the broadcast mixes may comprise a different combination of the digital audio channels. Additionally or alternatively, the relative volumes of one, several or each of the digital audio channels may differ between the broadcast mixes generated.

In the arrangement depicted, the digital audio workstation 126 comprises a computing device communicatively coupled to a mixing console 128. The computing device and mixing console 128 are together configured to allow an operator of the digital audio workstation to individually adjust each of the broadcast mixes 36. The digital audio workstation 126 may also be coupled to a mix display screen 130 configured to allow the parameters defining each of the broadcast mixes to be monitored by the operator.

As described above, the digital audio channels 30, 32, 34 may comprise digital input audio channels 30, corresponding to the input audio channels 20 and/or digital audio mix channels 32, 34, corresponding to the monitor mixes 22 and main mix 24 respectively. The broadcast mixes 36 may comprise combinations of the digital input audio channels 30, the relative volumes of which have been adjusted by the digital audio workstation 126. Additionally or alternatively, the broadcast mixes 36 may comprise one or more of the digital audio mixes 32, 34.

In some arrangements, the broadcast mixes comprising the digital audio mixes 32, 34 may not be adjusted or combined with any other audio channels to provide the broadcast mixes 36. This may allow the main mix and/or one or more of the monitor mixes to be broadcast by the audio broadcast system 1c and listened to by users of the personal audio receivers 200. However, it is equally envisaged that in other arrangements of the disclosure, one or more of the broadcast mixes 36 may comprise a combination of the digital audio mixes 32, 34 and the digital audio input channels 30.

As mentioned above, in some arrangements of the disclosure, the monitor mixes 22 and/or main mix 24 may be sent to the monitor amplifiers 112 and main amplifiers 118 directly from the respective mixers. The mixes may not be sent to the stage audio distribution box 120, and hence, the mixes may not be input to the audio broadcast equipment 1c. In such arrangements, the digital audio workstation 126 may be configured to adjust the relative volumes of the digital audio input channels 30 in order to generate broadcast mixes that substantially correspond to one or more of the monitor mixes 22 and/or the main mix 24.

Referring to FIG. 1b, the digital audio workstation 126 may comprise one or more digital audio outputs 126a. 126b. The digital audio workstation 126 may output the broadcast mixes 36 via the digital audio outputs. The broadcast mixes may be output to a multiplexor 132 of the audio broadcast equipment 1c.

In the arrangement depicted in FIG. 1b, the digital audio workstation 126 comprises two digital outputs. A first digital output 126a is configured to output a first digital output signal 38a comprising a first broadcast mix corresponding to the main mix and a second digital output 126b is configured to output a second digital output signal 38b comprising four broadcast mixes comprising digital audio input channels that have been adjusted and combined by the digital audio workstation 126.

In other arrangements of the disclosure the digital audio workstation 126 may comprise a different number of outputs. Different numbers and/or combinations of the broadcast mixes 36 may be output from the digital audio workstation 126 via different ones of the digital outputs 126a, 126b. For example, the digital audio workstation 126 may be configured to generate 2, 3, 5 or any desirable number of broadcast mixes 36 comprising combination of the digital input audio channels 30 and/or digital audio mixes 32, 34. Each of the broadcast mixes may be output via a single digital output of the digital audio workstation or may be output from more than two digital outputs.

In one arrangement of the disclosure (not shown), the digital audio workstation 126 may be replaced by one or more digital audio mixers, each configured to receive the digital audio signals 30, 32, 34 and output a broadcast mix 36 comprising a different combination of the digital audio signals. The digital audio mixers may be similar to the monitor mixer 110 and the main mixer 116 described above, however, the digital audio mixers may be configured to operate using digital audio signals.

In a further alternative arrangement, the digital audio workstation 126 may be replaced by one or more further mixers. The further mixers may be analogue devices and may each receive the input audio channels 20, monitor mixes 22, and the main mix 24 from the stage audio distribution box 120 and may each be configured to adjust the relative volumes of each of the audio signals to generate analogue broadcast mixes. The analogue broadcast mixes may be input to the ADCs 124 to generate digital versions of the broadcast mixes to be processed by the audio broadcast equipment 1c.

The digital audio workstation 126 may further comprise a clock source 126c configured to generate a timing signal 40. The timing signal 40 may be used by the audio broadcast equipment 1c to synchronise the transmission of digital signals within the audio broadcast system 1c. For example, the transmission of the digital audio signals from the ADCs 124 to the digital audio workstation 126 and the transmission of the broadcast mixes 36 from the digital audio workstation 126 to the multiplexer 132 may be synchronised according to the timing signal 40. Additionally, the ADCs 124 may be configured to synchronise their operation, e.g. the sampling of analogue signals input to the ADCs, according to the timing signal 40.

In order to allow the operation of the audio broadcast equipment 1c to be synchronised in this way, the timing signal 40 may be output from one or more of the digital outputs 126a. 126b, e.g. together with the broadcast mixes 36. The audio broadcast equipment 1c may comprise one or more digital splitters 134. The digital splitters may be configured to receive the digital output signals 38a, 38b from the digital outputs 126a, 126b of the digital audio workstation 126 and split the digital output signals 38a, 38b to create split digital signals 38a′, 38b′. The split digital signal may be substantially the same as the digital output signals 38a, 38b and may comprise the timing signal 40. The split digital output signals 38a′, 38b′ may be input to the ADCs 124.

In other arrangements (not shown), the ADCs 124 may comprise the clock source, and the operation of the audio broadcast equipment 1c may be synchronised according to a timing signal generated by the ADCs. In such arrangements, the timing signal from the ADCs 124 may be provided to the audio digital workstation 126, e.g. together with the digital input audio channels 30 and/or digital audio mix channels 32, 34.

The timing signal from the ADCs 124 may be transmitted from the digital audio workstation 126 to the multiplexor 132, e.g. via the digital audio outputs 126a, 126b. Alternatively, the timing signal may be transmitted from the ADCs 124 to the multiplexor 132 directly. For example, the digital signal splitters 134 may be provided between the ADCs 124 and the digital audio workstation 126 and may provide a split digital signal comprising the timing signal to the multiplexer 132.

In the arrangement depicted in FIG. 1b, the multiplexer 132 is configured to receive the digital output signals 38a, 38b from the digital audio workstation 126, e.g. which have passed though the digital signal splitters 134. The multiplexor 132 is configured to encode one, several or each of the broadcast mixes using an audio codec configured to allow low latency encoding, transmission and decoding of a digital audio signal. For example, the multiplexer 132 may encode the broadcast mixes 36 using the CELT codec.

The multiplexor 132 may be configured to process one or more of the broadcast mixes 36 to generate metadata 42 relating to the broadcast mixes, e.g. data describing the broadcast mixes 36. The metadata 42 may describe the waveform of the broadcast mixes and/or properties of the waveform. The metadata 42 may comprise timing and/or frequency information relating to the broadcast mixes 36. The metadata 42 may be generated by the multiplexor 132 substantially in real time, such that a stream of metadata 42 is generated, which is synchronised with the broadcast mixes 36 received from the digital audio workstation 126

In the arrangement shown in FIG. 1b, the broadcast mix 36 provided within the first digital output signal 38a, which corresponds to the main mix 24 is processed to generate the metadata 42. However, in other arrangements, a different one of the broadcast mixes 36 may be processed to generate the metadata 42. The metadata 42 may be used, as described below, to allow the audio broadcast by the audio broadcast equipment 1c to be synchronised with the audio projected into the audience area by the audio projection equipment 1b at the location of an attendee.

In some arrangements, the digital audio workstation 126 may be configured to generate a synchronisation broadcast mix. The synchronisation broadcast mix may be configured such that accurate synchronisation may be performed using metadata generated from the synchronisation broadcast mix. For example, the synchronisation broadcast mix may comprise the digital input audio channels expected to include audio in desirable frequency ranges. In such arrangements, the metadata 42 may be generated based on the synchronisation broadcast mix, however the audio of the synchronisation broadcast mix may not be multiplexed and or transmitted by the audio broadcast equipment 1c, as descried below.

The broadcast mixes 30 and the metadata 42 may be modulated, e.g. digitally modulated, and/or multiplexed together by the multiplexor 132 in order to be transmitted using a single communication channel, bandwidth or frequency. For example, the broadcast mixes 36 and metadata 42 may be encoded using a Quadrature Amplitude Modulation (QAM) technique, such as 16-bit QAM. In alternative arrangements of the present disclosure, several or each of the broadcast mixes 36 and/or the metadata 42 may be transmitted separately using a separate wireless communication channel, bandwidth, or frequency.

The multiplexor 132 is configured to process the encoded broadcast mixes and/or metadata 42 to generate a transmission data stream 44 to be transmitted by the audio broadcast equipment 1c. The multiplexor 132 outputs the transmission data stream to one or more transmitters 138 provided within the audio broadcast system 1c. The transmitters 138 may be configured to transmit the transmission data stream 44 as one or more wireless signals 46, using a wireless communication system, such as radio, digital radio, Wi-Fi®, or any other wireless communication system. The wireless signals 46 are received by the personal audio receivers 200 as described in detail below.

As shown in FIG. 1b, the audio broadcast equipment 1c comprises a display 135 and one or more user input devices 136, such as a mouse and keyboard, associated with the multiplexer 132, to allow the operation of the multiplexer to be controlled. For example, in order to select which of the broadcast mixes 36 should be used to generate the metadata 42 and/or which of the broadcast mixes should be multiplexed and/or transmitted.

In the arrangement shown in FIG. 1b, the multiplexor 132 is coupled to each of the transmitters 138 and provides the transmission data stream 44 to each of the transmitters. In other arrangements of the disclosure, the multiplexor 132 may be coupled to one or several of the transmitters 138 and one or more of the transmitters 138 may not be coupled to, e.g. directly coupled to, the multiplexer 132. The one or more transmitters that are coupled to the multiplexer 132 may receive the transmission data stream 44 from the multiplexer 132 and may relay the transmission data stream 44 on to the others of the transmitters 138, e.g. the transmitters not directly coupled to the multiplexer 132. Relaying the transmission data stream 44 may allow the area over which the broadcast mixes 36 and metadata 42 is transmitted to be extended.

The transmitters 138 may be coupled to the multiplexor 132 and/or the others of the transmitters 138 by a twisted pair cable, such as a Category 5, Category 5e or Category 6 cable. The transmitters 138 may receive electrical power from the multiplexor 132 and/or the other transmitters via the twisted pair cable in order to operate to broadcast the transmission data stream 44.

The wireless signals 46 sent by the transmitters 138 may be transmitted using an ultra-low latency transfer protocol, such as the ULoLat protocol. In order to allow the latency of communications between the transmitters 138 and the personal audio receivers 200 to be low, the transmitters 138 may be configured to operate in a broadcast only mode. The personal audio receivers 200 may not be configured to send any acknowledgement messages to the transmitters 138 to confirm that the wireless signals 46 have been received. The transmitters 138 may continue sending the wireless signals 46 without any acknowledgement messages being received.

In some arrangements, it may be desirable for additional information 48 to be broadcast by the audio broadcast system 1c. The additional information 48 may comprise, for example, bibliographic or lyric information relating to the broadcast mixes 36. Additionally or alternatively, the additional information 48 may comprise the identifying information or authorisation information described below.

The additional information 48 may be combined with the broadcast mixes 36 and/or metadata 42 by the multiplexor 132 to form the transmission data stream 44. Additionally or alternatively, at least part of the additional information 48 may be processed by the multiplexor 132 to generate a further transmission data stream that may be sent to the transmitters 138 or one or more further transmitters (not shown). The further transmission data steam may be transmitted by the transmitters 138 or further transmitters within a further wireless signal.

In some arrangements, the additional information 48 may relate or correspond to one or more of the broadcast mixes 36 being transmitted within the transmission data stream 44. For example, the additional information 48 may comprise lyric information for a song, the audio of which is encoded within the transmission data stream 44. Hence, the additional information 48 may be transmitted at substantially the same time that the broadcast mixes 36 corresponding to the additional information 48 are being transmitted.

Regardless of whether the additional information 48 is transmitted by the transmitters 138, e.g. together with the broadcast mixes 36 and/or metadata 42, or the further transmitters, the additional information 48 may be broadcast within substantially the same area, e.g. over substantially the same range, that the broadcast mixes 36 and metadata 42 are being transmitted. As depicted in FIG. 1b, the multiplexor 132 may be coupled to a management workstation 140. The multiplexor 132 may be configured to receive the additional information 48 from the management workstation 140. The multiplexer 132 may also be configured to send diagnostic information relating to the audio broadcast system 1c to the management workstation 140. In particular, the multiplexer 132 may send diagnostic information relating to the operation of the transmitters 138 and/or the further transmitters to the management workstation 140.

The multiplexer 132 may be configured to generate a transmission timing signal 50. The transmission timing signal 50 may be based, or at least partially based, on the timing signal 40 provided to the multiplexer 132 by the digital audio workstation 126 or the ADCs 124, as described above. The transmission timing signal 50 may be sent by the multiplexer 132 to each of the transmitters 138. The transmitters 138 may be configured to relay the transmission timing signal 50 to any others of the transmitters 138 that are not directly coupled to the multiplexer 132.

The transmission data stream 44 may be comprised of a plurality of data packets. The transmitters 138 may be configured to transmit the data packets according to the transmission timing signal 50, such that the transmissions of each data packet by each of the transmitters 138 is substantially synchronised.

In alternatively arrangements of the disclosure, the multiplexer 132 may comprise the clock source and may be configured to generate the timing signal 40. The multiplexer may be configured to supply the timing signal 40 to the ADCs 124 and/or the digital audio workstation 126.

As described above, the transmissions made by the audio broadcast equipment 1c, 200c may be received by one or more personal audio receivers 200 provided within the audio system 1.

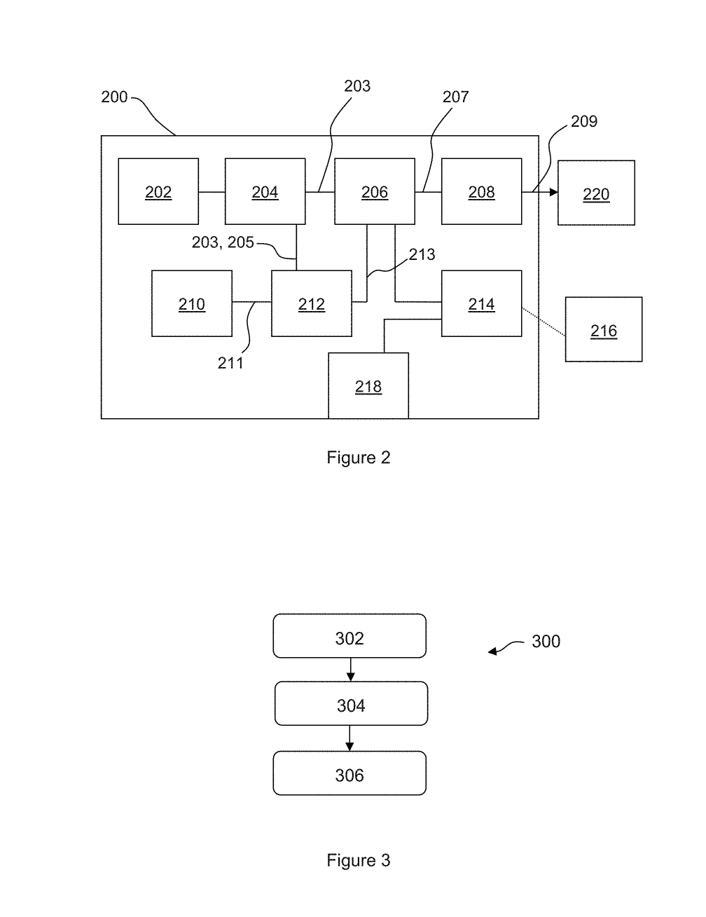

With reference to FIG. 2, the personal audio receiver 200, according to an arrangement of the present disclosure, will now be described. The personal audio receiver may be a portable device that a user may carry with them. The personal audio receiver 200 may be a hand held device. Additionally or alternatively, the personal audio receiver may be adapted to be worn by the user. For example, the personal audio receiver may be adapted to be worn on a user's belt, on an arm or wrist strap, on a shoulder strap or on a lanyard around the user's neck, carried in a pocket or fixed to clothing.

As depicted in FIG. 2, the personal audio receiver 200 comprises an audio signal receiver 202, a decoder 204, a personal mixer 206, and a personal equaliser 208.

The audio signal receiver 202 is configured to receive the wireless signals 46 comprising the broadcast mixes 36 and metadata 42 transmitted by the transmitters 138. As described above, the transmitters 138 may encode the signal, for example using a QAM technique. Hence, the decoder 204 may be configured to demultiplex and/or demodulate (e.g. decode) the received signal as necessary to recover each of the broadcast mixes 36 and the metadata 42, as one or more decoded audio signals 203 and wirelessly received metadata 205 respectively.

As described above, the broadcast mixes may each comprise a different mix of input audio channels 20 from the stage audio distribution box 120, which have been recorded from the instrumentalists and/or vocalists performing on the stage 2. For example, a first broadcast mix may comprise a mix of input audio channels 20 in which the volume of the vocals has been increased with respect to the other input audio channels 20; in a second broadcast mix the volume of an input audio channel 20 from the instrument pick-up 8 of a lead guitarist may be increased with respect to the other input audio channels 20.

The personal mixer 206 is configured to vary the relative volumes of each of the decoded audio signals 203 to create a personal mix to be listened to by the user of the personal audio receiver 200. The mix created by the personal mixer 206 may be selectively controlled by a user of the personal audio receiver 200, as described below. The user may set the personal mixer 206 to create a mix of one or more of the decoded audio signals 203.

In a particular arrangement, each of the broadcast mixes 36 is mixed by the digital audio workstation 126 (depicted in FIG. 1b) such that each broadcast mix 36 comprises a single input audio channel 20 recorded from one microphone 6 or instrument pick-up 8. The personal mixer 206 can therefore be configured by the user to provide a unique personalised mix of audio from the performers on the stage 2. The personal audio mix may be configured by the user to improve or augment the ambient sound, e.g. from the front speakers and additional speakers 122a, 122b, heard by the user.

A mixed audio signal 207 output from the personal mixer 206 is processed by the personal equaliser 208. The personal equaliser allows the volumes of selected frequency ranges within the mixed audio signal 207 to be increased or decreased. The operation of the personal equaliser 208 may be configured by a user of the personal audio receiver 200 according to their own listening preferences. An equalised audio signal 209 from the personal equaliser 208 is output from the personal audio mixing device 200.

As shown in FIG. 2, the personal audio receiver 200 may comprise one or more audio transducers 220 associated with the personal audio receiver. The audio transducers 220 may receive the equalised audio signal 209 from the personal audio receiver 200 and may reproduce the equalised audio signal 209 as sound.

The audio transducers 220 may be configured to project sound within a short range of the personal audio receiver 200. In some arrangements, the audio transducers 220 may be configured to allow only a user of the personal audio receiver 200 to listen to audio produced by the personal audio receiver 200, for example, the audio transducers 220 may be a pair of headphones, such as over-ear, on-ear, in-ear or earbud headphones. The personal audio receiver 200, may comprise a plug or jack allowing the headphones to be coupled to the personal audio receiver 200 in order to receive the equalised audio signal 209.

The audio transducers 220 may be configured such that the user is able to listen to the ambient, acoustic sound at the location of the user at the same time as the sound being produced by the personal audio receiver 200. For example, if the audio transducers 220 comprise headphones, a body of each headphone may comprise an aperture configured to allow ambient acoustic sound to enter the user's ear canal together with the audio being provided by the personal audio receiver 200. The ambient acoustic sound may include sound being projected by the audio projection equipment 1b and/or the voices of other attendees at the event. Configuring the audio transducers 220 in this way may allow the user to leave the headphones in position within or over their ears during the performance whilst being able to comfortably hear sounds being produced around them, e.g. by other attendees at the performance. Allowing the user to listen to the sound projected by the front speakers 122a and/or additional speakers 122b may improve the listening experience of the user, for example, due to the Haas effect described below.

When a person hears substantially the same sound originating from two locations at substantially the same time, e.g. such that the two sounds are separated by less than the person's echo threshold, the person perceives all of the sound as a single fused sound that appears to originate from the location of the sound that was heard first. This psychoacoustic effect is often referred to as the precedence effect or the Haas effect. By allowing ambient sound to enter the ear canal, the personal audio receiver 200 may make use of the Haas effect to create the impression that all of the sound heard by the user is being projected from the front speakers 122a or additional speakers 122b.

Alternatively, if desirable, the user may listen to the personal, custom audio content in a way that excludes other external noises, for example by using noise cancelling/excluding headphones.

In order for the user of the personal audio mixing device 200 to configure the personal mixer 206 and personal equaliser 208 according to their preferences, the personal audio mixing device 200 may comprise one or more user input devices, such as buttons, scroll wheels, or touch screen devices (not shown). Additionally or alternatively, the personal audio mixing device 200 may comprise a user interface communication module 214.

As shown in FIG. 2, the user interface communication module 214 may be configured to communicate with a user interface device 216. The user interface device may comprise any portable computing device capable of receiving input from a user and communicating with the user interface communication module 214. For example, the user interface device 216 may be a mobile telephone, e.g. a smartphone, or tablet computer. The user interface communication module 214 may communicate with the user interface device 216 using any form of wired or wireless communication. For example, the user interface communication module 214 may comprise a Bluetooth® communication module. The user interface communication module may be configured to establish a connection with, e.g. pair with or tether to, the user interface device 216 using wireless communication, e.g. in order to establish a two-way communication link between the user interface communication module 214 and the user interface device 216.

By pairing with the user interface device 216, the user interface communication module 214 may able to receive each user input transmitted by the paired user interface device whilst ignoring or disregarding any user inputs being transmitted by another user interface device using the same wireless communication method.

The user interface device 216 may run specific software, such as an app, which provides the user with a suitable user interface, such as a graphical user interface, allowing the user to easily adjust the settings of the personal mixer 206 and personal equaliser 208. The user interface device 216 communicates with the personal audio receiver 200 via the interface communication module 214 to communicate any audio content settings, which have been input by the user using the user interface device 216.

The user interface device 216 and the personal audio mixing device 200 may communicate in real time to allow the user to adjust the mix and equalisation of the audio delivered by the personal audio mixing device 200 during the concert. For example, the user may wish to adjust the audio content settings according to the performer on the stage or a specific song being performed.

The personal audio receiver 200 further comprises a microphone 210. The microphone may be a single channel microphone. Alternatively the microphone may be a stereo or binaural microphone. The microphone 210 is configured to record an ambient sound at the location of the user, for example the microphone may record the sound of the crowd and the sound received by the user from the speakers 122. The sound is converted by the microphone to an acoustic audio signal 211, which may be input to the personal mixer 206. The user of the personal audio mixing device can adjust the relative volume of the acoustic audio signal 211 together with the decoded audio signals 203. This may allow the user of the device 200 to continue experiencing the sound of the crowd at a desired volume whilst listening to the personal audio mix created on the personal audio mixing device 200, particularly when the transducers 220 comprise noise excluding or cancelling headphones.

Prior to being input to the personal mixer 206, the acoustic audio signal 211 is input to an audio processor 212. The audio processor 212 also receives the decoded audio signals 203 from the decoder 204. The audio processor 212 may process the acoustic audio signal 211 and the decoded audio signals 203 to determine a delay between the acoustic audio signal 211 recorded by the microphone 210 and the decoded audio signals received and decoded from the wireless signals 46 transmitted by the transmitters 138.

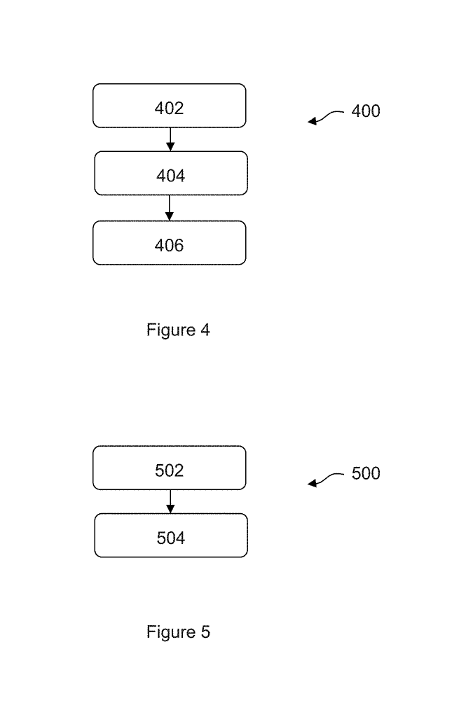

With reference to FIG. 4, in one arrangement of the disclosure, the audio processor 212 is configured to process the acoustic audio signal 211 and the decoded audio signals 203 according to a method 400. In a first step 402, the acoustic audio signal 211 and the decoded audio signals 203 are processed to produce one or more metadata streams relating to the acoustic audio signal 211 and the decoded audio signals 203, respectively. The metadata streams may contain information relating to the waveforms of the acoustic audio signal and/or the decoded audio signals. Additionally or alternatively, the metadata streams may comprise timing information.

In a second step 404, the audio processor 212 combines the metadata streams relating to one or more of the decoded audio signals 203 to generate a combined metadata steam, which substantially corresponds to the metadata steam generated from the acoustic audio signal. The audio processor 212 may combine different combinations of metadata streams before selecting a combination which it considered to correspond. In an alternative arrangement, the audio processor 212 may combine the decoded audio signals 203 prior to generating the metadata streams, in order to provide the combined metadata steam.

In a third step 406, the audio processor 212 compares the combined metadata stream with the metadata stream relating to the acoustic audio signal 211 to determine a delay between the acoustic audio signal 211 recorded by the microphone 210, and the decoded audio signals 203.

The audio processor 212 may delay one, some or each of the decoded audio signals 203 by the determined delay and may input one or more delayed audio signals 213 to the personal mixer 206. This allows the personal audio content being created on the personal audio mixing device 200 to be synchronised with the sounds being heard by the user from the front speakers 122a and additional speakers 122b, e.g. the ambient audio at the location of the user. As noted above, it may be desirable for the personal audio receiver 200 to make use of the Haas effect in order to create the impression that all of the sound being heard by the user is originating from speakers at the event. In this case, the audio processor 212 may delay the decoded audio signals 203 by a period of time that is longer than the calculated delay. The difference between the calculated delay and the delay applied to the decoded audio signals 203 may be sufficiently small that the user does not perceive any echo or reverb effects.

As the user moves around the audience area 4 and the distance between the audience member and the speakers 122 varies, the required delay may vary also. Additionally or alternatively, environmental factors such as changes in temperature and humidity may affect the delay between the acoustic audio signal 211 and the decoded audio signals 203. These effects may be emphasised the further an audience member is from the speakers 122.

In order to maintain synchronisation of the personal audio content created by the device, with the ambient audio, the audio processor 212 may continuously update the delay being applied to the decoded audio signals 203. It may therefore be desirable for the audio processor 212 to reduce the time taken for the audio processor to perform the steps to determine the delay.

The digital audio workstation 126 may output a broadcast mix 36 corresponding to the main mix 24 being projected by the speakers 122. The digital audio workstation may receive the main mix 24 from the ADCs 124, alternatively, the digital audio workstation 126 may be configured to generate at least one of the broadcast mixes 36, such that it corresponds to the main mix 24. In this case, at least one of the decoded audio signal 203 may correspond to the acoustic audio signal 211. The audio processor 212 may then process only the acoustic audio signal 211 and the decoded audio signal 203 that corresponds to the main mix 24, and hence the ambient audio content recorded by the microphone 210 to provide the acoustic audio signal 211.

With reference to FIG. 5, in other arrangements of the present disclosure, the audio processor 212 may determine a required delay using a method 500, according to another arrangement of the present disclosure.

In a first step 502, the acoustic audio signal 211 is processed to produce a metadata stream. In a second step 504 the metadata stream relating to the acoustic audio signal is compared with the wirelessly received metadata 205, to determine a delay between the acoustic audio signal 211 and the decoded audio signals 203.

As described above, the metadata 42 transmitted by the transmitters 138 and received wirelessly by the personal audio mixer 200 may relate to a broadcast mix 36 output from the digital audio workstation 126. In particular, the metadata 42 may relate to a broadcast mix 36 that corresponds to the main mix 24 being projected by the speakers 122. Hence, the wirelessly received metadata 205 may be suitable for comparing with the metadata stream generated from the acoustic audio signal 211 to determine the delay. In addition, by applying the wirelessly received metadata 205 to determine the required delay, rather than processing one or more of the decoded audio signals 203 to generate metadata streams, the audio processor 212 may calculate the delay faster. This may lead to improved synchronisation between the personal audio content created by the personal audio receiver 200 and the ambient audio heard by the user.

Before a performance begins and/or during intervals or pauses during the event, the operators of the venue, the event promotors and/or the performers performing at the event may wish to send information and/or messages to the attendees. For example, the operator of the venue may wish to send messages promoting facilities provided at the event venue and/or the performers may want to share their pre-show preparations with the attendees or provide them with a preview of their performance to increase their excitement prior to the performance.

In some venues, the pre-show messages may be displayed on one or more display screens provided at the venue (not shown) and sound accompanying the pre-show messages may be projected throughout the venue using the speakers 122. When the venue is provided with the audio broadcast equipment 1c, it may be desirable for the sound accompanying the pre-show messages to be broadcast to the attendees in the same way as the sound produced during the performance, as described above.

It may be desirable for some or all of the pre-show messages to be shown only to attendees using one of the personal audio receivers 200. For example, a performer may wish to send a message to attendees who are using the personal audio receivers 200 to enhance their experience of the performance. In this case, the pre-show message may not be displayed on the display screen provided at the venue and may instead be broadcast to the personal audio receivers 200 using the transmitters 138.

The personal audio receivers 200 may not comprise display screens, and hence, the personal audio receiver 200 may not be able to display a video component of the pre-show message. However, as mentioned above, the personal audio receiver 200 may be paired with a user interface device 216. The user interface device 216 may comprise a display screen, and hence, the personal audio receiver 200 and/or the user interface device 216 may be configured to allow the attendees to view the pre-show messages using the user interface device display screen.

The user interface device 216 may comprise an audio transducer or may comprise an audio output configured to allow an audio transducer, such as a pair of headphones, to be coupled to the user interface device 216. Hence, the user interface device may also be capable of playing back the audio component of the media. However, the user may be prepared to listen to the sounds from the audio broadcast equipment 1c using the personal audio receiver 200 and may be wearing headphones coupled to the personal audio receiver. This may be the case particularly if the message is being sent shortly before the start of the performance or during a break in the performance, e.g. between acts. It may be inconvenient for the user to switch between listening to the personal audio device 200 and the user interface device 216, and hence, it may be desirable to playback the audio component of the media using the personal audio receiver 200, e.g. the audio transducers coupled to the personal audio receiver 200.

With reference to FIG. 3, the personal audio receivers 200 may be configured to show media, such as the pre-show messages, to the attendees using a method 300, according to arrangements of the present disclosure. The method 300 comprises a first step 302 in which the media is received using the personal audio receiver 200. In a second step 304, a video component of the media may be played by the user interface device 216, e.g. using a display screen provided on or associated with the user interface device. In a third step 306 an audio component of the media may be played by the personal audio receiver 200, e.g. using the audio transducers 220. The second and third steps 304, 306 may be performed at substantially the same time. For example, the second and third steps 304, 306 may be performed such that the play back of the audio and video components of the media is substantially synchronised.

As described above, the user interface device 216 may be configured to communicate with the personal audio receiver 200 via the user interface communication module 214. In some arrangements the user interface device 216 may be configured to connect to or pair with the personal audio receiver 200 using a wireless communication system. However, in other arrangements, the personal audio receiver 200 may be connected to the user interface device 216 using a wired connection. Connecting or pairing in these ways may allow two-way communication between the personal audio receiver 200 and the user interface device

The personal audio receiver 200 may be configured to transmit the media or a component of the media, e.g. the video component of the media, to the user interface device 216 using the wireless communication system or the wired connection between the devices.

A first wireless signal may be received at the personal audio receiver 200 from the transmitter 138 comprising a plurality of data packets. Each data packet may comprise a portion of the audio component and/or video component of the media. The decoder 204 of the personal audio receiver 200 may decode the plurality of data packets to recover the media. e.g. the audio and video components of the media from the first wireless signal.

In some arrangements, the personal audio receiver 200 and/or the user interface device 216 may be configured to play back the media at substantially the same time that the media is being received by the personal audio receiver. In this arrangement, the decoder 204 may be configured to send the audio component of the media to the personal audio mixer 206 in the same way as the decoded audio signals 203 described above. The video component of the media may be sent from the decoder 204 to the user interface device 216 via the user interface communication module 214. The user interface device 216 may be configured to play back the video component using the display screen of the user interface device 216 at substantially the same time that the media is received.

The process of transmitting the media or the video component of the media to the user interface device 216 may take a significant period of time, e.g. sufficient to lead to an offset or lag, between the play back of the audio component by the personal audio receiver 200 and the playback of the video component by the user interface device 216. The lag may be noticeable to the user. In order to correct for the lag, when the personal audio receiver 200 is receiving and playing back media, the audio processor 212 may be configured to delay the audio component by a predetermined period that is sufficient to allow the playback of the audio and video components to be substantially synchronised.

In some cases, it may not be desirable for the media to be played back at substantially the same time that the media is being received by the personal audio receiver 200. For example, it may be desirable for a user to be able to selectively begin playback of the media when they want to view the pre-show message. In this case, it may be desirable for the media to be stored on the personal audio receiver 200 and/or the user interface device 216 in order to be available when playback is requested by the user.

In some arrangements, the personal audio receiver 200 may be provided with sufficient memory to allow the media to be stored on the personal audio receiver 200. Alternatively, the personal audio receiver 200 may have sufficient memory to store the audio component of the media and the video component of the media may be stored on the user interface device 216.

It may be desirable to limit the number of components or modules in the personal audio receiver 200. Hence, in other arrangements, the personal audio receiver 200 may not be provided with sufficient memory to store the media or a component of the media. In this case, the personal audio receiver 200 may be configured to transmit the media, e.g. the audio and video components of the media, to the user interface device 216. e.g. using the user interface communication module 214. The media, e.g. the audio and video components of the media may be stored on the user interface device 126/. The user interface device 216 may have sufficient memory to store the audio and video component of the media.

Although the personal audio receiver 200 may not have sufficient memory to store a component of the media, the personal audio receiver may comprise a buffer memory configured to store one or more packets of data received from the transmitter 138 before the media provided in the data packets is transmitted to the user interface device 216. The buffer memory may be sufficient to store the data received from the transmitter whilst the data is being decoded and/or prepared for transmission to the user interface device 216. Once the media has been transmitted to the user interface device 216, the media may no longer be stored on the personal audio receiver 200.

In the arrangement shown in FIG. 2, the buffer memory may be provided as part of the decoder 204. Additionally or alternatively the buffer memory may be provided as part of any other component or module of the personal audio receiver 200, such as the user interface communication module 214. In some arrangements, the buffer memory may be distributed over two or more of the components or modules of the personal audio receiver 200. Alternatively, the buffer memory may be provided as a separate component or module of the personal audio receiver 200.

As described above, the transmitter 138 may communicate with the personal audio receivers 200 using a broadcast communication system. Accordingly, the transmitter 138 may not be configured to receive acknowledgement messages from the personal audio receivers 200, indicating that they have successfully received the data packets provided within the first wireless signal, before proceeding to send further data packets. Hence, in some circumstances, a particular personal audio receiver 200 may not receive all of the data packets, e.g. comprising all of the portions of the media, when they are transmitted by the transmitter 138. For example, the user of the personal audio receiver 200 may move out of range of the transmitter 138 during part of the transmission or may move into a position where objects or other attendees between the user and the transmitter 138 degrade the reception of the first wireless signal at the personal audio receiver 200. Additionally, if the pre-show messages are being transmitted at a time when attendees are arriving at the event venue. One or more attendees may arrive at the venue after the start of the media has been broadcast and may not receive an initial portion of the pre-show message.

In order to ensure that each of the attendees having a personal audio receiver 200 is able to successfully receive all of the media data transmitted by the transmitter 138, regardless of intermittent reception, the first wireless signal may be repeated once, twice or a plurality of times. The personal audio receiver 200, e.g. the decoder 204, may be configured to decode each packet of data received from the transmitter 124 and store the audio and/or video components of the media, e.g. the portion of the component provided in each data packet, within the memory of the personal audio receiver 200 and/or the user interface device 216. The portions of the components may be stored in the memory or memories such that, after substantially all of the portions of the components have been received, the personal audio receiver 200 and/or the user interface device is able to play back substantially all of the media, e.g. the full length of the media.

The method 300 may include a step in which a user input is received at the user interface device 216 requesting play back of the media. When the user input is received, the user interface device may begin playing back the video component of the media using the display screen of the user interface device 216.

As described above, in some arrangements the audio component may be stored within a memory of the personal audio receiver 200. When the user input is received, the user input may be transmitted to the personal audio receiver 200, e.g. via the user interface communication module 214. When the personal audio receiver 200 receives the user input, the personal audio receiver may begin playing back the audio component of the media, such that the playback of the audio component and the video component are substantially synchronised.

In other arrangements, in which the audio and video components of the media are stored within a memory of the user interface device 216, when the user input is received, the user interface device 216 may begin transmitting the audio component of the media to the personal audio receiver 200, e.g. via the user interface communication module 214. The personal audio receiver 200 may receive the audio component and may play back the audio component, e.g. using the audio transducers 220. The user interface device 216 and/or the personal audio receiver 200 may be configured such that the playback of the audio component by the personal audio mixer 200 and the playback of the video component by the user interface device 216 is substantially synchronised.

As described above, the personal audio receiver 200 may be connected to, or paired with, the user interface device 216 using a wireless communication system. At some events, many or all of the attendees may be using a personal audio receiver 200, and hence configuring the personal audio receiver 200 and/or the user interface device 216 to connect to or pair with each other may be challenging. For example, it may be difficult for a user to ensure that their user interface device 216 is pairing with their personal audio receiver 200.

In order to facilitate the paring of the portable audio receiver 200 and user interface device 216, the portable audio receiver may be provided with a visual identifier, such as a barcode, two-dimensional barcode or any other visual identifier. The user interface device 216 may comprise a camera. The user interface device 216 may be configured to capture an image of the personal audio receiver 200, e.g. of the visual identifier of the personal audio receiver, using the camera. The user interface device 216 may be configured to process the image to determine an identity of the personal audio receiver 200. The user interface device may pair with the personal audio receiver by applying the determined identity.

Additionally or alternatively, as depicted in FIG. 2, the personal audio receiver 200 may comprise a Near Field Communication (NFC) module 218. The NFC module may comprise an NFC tag which can be read by an NFC reader provided on the user interface device 216. The NFC tag may comprise identifying data which can be read by the user interface device 216, to allow the user interface device to couple with the personal audio mixing device 200, e.g. with the user interface communication module 214. Additionally or alternatively, the NFC tag may comprise authorisation data that can be used by the user interface device 216 to access services provided at the performance venue.

In some arrangements, the NFC module 218 may further comprise an NFC radio. The radio may be configured to communicate with the user interface device 216 to receive the audio content setting from the user interface device, e.g. as an alternative to receiving the audio content setting via the user interface communication module 214. Alternatively, the NFC radio may be configured to read the audio content setting from another source, such as an NFC tag provided on a concert ticket, or smart poster at the venue.

As described above, the transmitter 138 or a further transmitter of the audio broadcast equipment 1c may be configured to transmit additional information 48, e.g. as part of the wireless signal 46 or as a further wireless signal. The personal audio receiver 200 may be configured to process the wireless signal 46 or further wireless signal to extract the additional information 48.

The additional information 48 may comprise identification information relating to one or more of the personal audio receivers 200. The personal audio receivers may be uniquely identifiable, for example each of the personal audio receivers 200 may be assigned an identifier or address, such as a Media Access Control (MAC) address. The identification information may identify one or more of the personal audio receivers 200 according to their identifier or address.

The identification information may be provided within the additional information 48 to indicate that the additional information 48 is intended to be received by the personal audio receiver with a corresponding identifier or address.

Each of the personal audio receivers 200 may be configured to consider the identification information to determine whether the identification information corresponds to the identifier of the personal audio receiver 200. In other words, each of the personal audio receivers 200 may be configured to determine whether the additional information 48 is intended to be received by them.

The additional information 48 may further comprise instructions and the personal audio receivers 200 may be configured to carry out the instructions if the identification information corresponds to the identifier of the personal audio receiver 200. In some arrangements, the instructions may be carried out by the personal audio receiver 200 in order to notify the user that the personal audio receiver 200 they are using has been identified, e.g. that identifying information corresponding to their personal audio receiver 200 has been received.

By transmitting the additional information 48, the media system 1 may be capable of identifying a particular attendee at an event using their personal audio receiver 200. The media system 1 may be configured to provide personalised messages to one or more attendees at the event via their portable audio receiver 200. For example a personal message sent to an attendee could inform the attendee that they have won a prize being awarded at the event.

In some arrangements, the identification information may identify, e.g. correspond to, more than one, e.g. a plurality, of the personal audio receivers 200. For example, the identification information may identify the personal audio receivers 200 of a plurality of users who have purchased tickets entitling them to additional services at the event.

Additionally or alternatively, the additional information 48 may comprise authorisation information. The authorisation information may be stored by the personal audio receiver 200, e.g. in a memory associated with the personal audio receiver 200. Alternatively, in some arrangements, the authorisation information may be sent from the personal audio receiver 200 to the user interface device 216, e.g. using the user interface communication module 214, and may be stored by the user interface device 216.

In other arrangements of the disclosure, the authorisation information may be received by the user interface device 216. e.g. directly received via a further wireless signal. In such arrangements, the authorisation information may be stored on the user interface device 216 and/or may be sent from the user interface device 216 to the personal audio receiver 200. Authorisation information sent to the personal audio receiver 200 may be stored on the personal audio receiver 200.

The authorisation data may allow the user of the personal audio receiver 200 and/or user interface device 216 to gain access to services being provided at the performance venue before, during and/or after the event. For example, the authorisation data may allow the user to enter a prize draw being performed at the event or allow the user to obtain discounts when purchasing performance related merchandise. Additionally or alternatively, the authorisation data may be used to authorise and/or request an audio download, e.g. comprising audio recorded during the performance, and/or to authorise the download of additional content relating to the audio download or to the event, as described below.

In some arrangements, the authorisation data may be transmitted together with the identification information. The authorisation data be stored by the personal audio receivers 200 that have identifiers or addresses corresponding to the identification information.

After the performance has finished, the user of the personal audio receiver 200 may wish to download an audio download comprising audio that the user has heard during the performance, e.g. which has been projected by the audio projection equipment 1b or broadcast by the audio broadcast equipment 1c or any other audio signal recorded or processed by the media system 1.

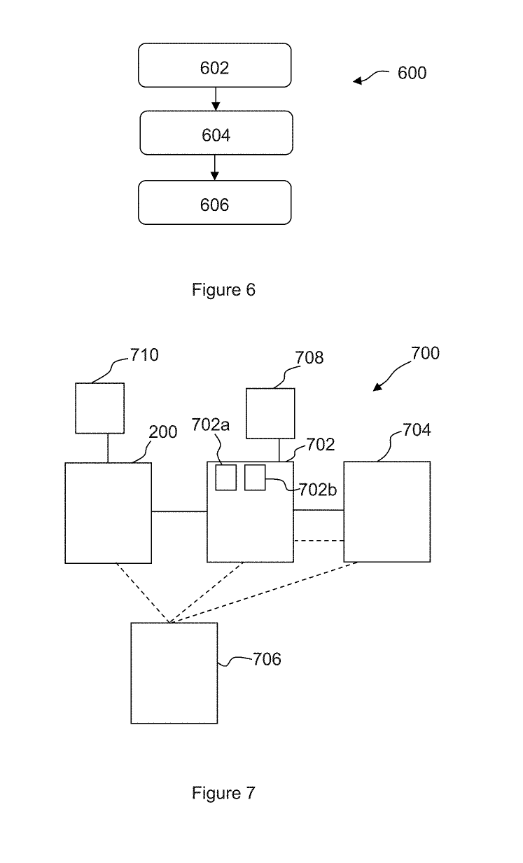

With reference to FIG. 6, in order to download an audio download comprising audio heard by the user during the performance, a method 600 according to arrangements of the disclosure may be performed to authorise and/or receive the audio download.

The method 600 comprises a first step 602 in which a first wireless signal, such as the wireless signals 46, the further wireless signal or any other wireless signal is received. The first wireless signal comprises authorisation data. In a second step 604 of the method, the audio download is requested using the authorisation data. In a third step 606, a transmission is received comprising the audio download. The audio download may comprise one or more downloaded audio channels.

As described above, the authorisation data may be broadcast by the transmitters 138 and/or further transmitters at the same time that the broadcast mixes 36 and metadata 42 is being broadcast by the transmitters 138. The method 600 may further comprise receiving the wireless signals 46 comprising the broadcast mixes, as described above with reference to FIGS. 1a, 1b and 2.

In some arrangements, the authorisation data being broadcast may correspond to a performer currently on stage and/or a song or movement being performed. Additionally or alternatively, the authorisation data may correspond to one or more of the broadcast mixes 36 being broadcast by the transmitters 138. When the audio download is requested using the authorisation data, the audio download received may comprise one or more of the corresponding broadcast mixes 36. In some arrangements, the audio download may comprise a recording of one, more than one or each of the corresponding broadcast mixes 36 being transmitted at the time that the authorisation data was broadcast.

In some arrangements of the disclosure, the audio download may be available for download without using the authorisation data. In such arrangements, requesting the audio download using the authorisation data. e.g. providing the authorisation data at substantially the same time that the audio download is requested, may allow additional content associated with the download to be received. The additional download may be, for example, an image or video clip relating to a performance.

With reference to FIG. 7, the audio download may be requested and received using an audio download system 700, according to arrangements of the present disclosure. The audio download system 700 comprises a receiver, such as the personal audio receiver 200 or the user interface device 216, and an audio downloading device 702. The personal audio receiver 200 and/or the user interface device 216 may be configured to receive the additional information comprising the authorisation data and the audio downloading device 702 is configured to download the audio download using the authorisation data.

The audio downloading device 702 may comprise a memory and may be configured to store the audio download in the memory for future playback.

The personal audio receiver 200 and/or the user interface device 216 may be communicatively coupled to the audio downloading device 702. The personal audio receiver 200 and/or the user interface device 216 may be configured to transfer the authorisation data to the audio downloading device 702 in order to request the download.

In some arrangements, the audio downloading device 702 may be the user interface device 216 described above. In other words, the functions of the audio downloading device 702 and the user interface device 216 may be performed by a single device, such as a smartphone, tablet computer or another portable computing device.

As described above, when the authorisation data is initially received by the personal audio device 200, the authorisation data may be transferred to the user interface device 216, e.g. by the personal audio device 200, when the authorisation data is received. The authorisation data may therefore be available within the memory of the user interface device 216 to perform the second step 604 of the method. In alternative arrangements, if the authorisation data has not been previously stored on the audio downloading device 702, the second step 604 may comprise the audio downloading device 702 requesting the authorisation data from the personal audio receiver 200 and/or the user interface device 216, and/or may comprise receiving the authorisation data from the personal audio receiver and/or the user interface device 216, prior to requesting the audio download using the authorisation data.

It will be appreciated that as the audio download may comprise a recording of the audio being heard by the user at the time that the authorisation data is received by the personal audio receiver 200 and/or the user interface device 216, the audio download may not be available for download when, e.g. immediately when, the authorisation data is received. However, the user of the audio downloading system 700 may wish to download the audio download as soon as it becomes available. In some arrangements, the audio download corresponding to a first performance may become available during a second, subsequent performance. When the function of the user interface device 216 and/or audio downloading device 702 is being performed by a smartphone or tablet computer, the user may request the audio download using the smartphone or tablet computer whilst still at the event.

The smartphone or tablet computer may perform the first, second and third steps 602, 604, 606 of the method 600 and may download the audio download using a mobile telecommunication network or another wireless communication system, such as Wi-Fi® available at the event venue.

When the functions of the audio downloading device 702 and the user interface device 216 are being performed by the same smartphone or tablet computer, the second and third steps 604, 606 of the method 600 may be performed by the audio downloading device 702 using a different communication system than the communication system being used by the user interface device 216 to communicate with the personal audio receiver 200. In this way, the audio downloading device 702, e.g. the smartphone or tablet computer, may continue performing the functions of the user interface device 216 whilst the audio download is being requested and received according to the method 600.

Although the smartphone, tablet computer or other portable computing device may be capable of downloading the audio download whilst the user is still at the event venue, e.g. attending a subsequent performance, many attendees at the event may be attempting to download the audio content or access other services using the mobile telecommunication network or other wireless communication system provided at the event venue. Receiving, e.g. downloading, the audio download may therefore be slow and/or unreliable. Hence, it may be desirable for the user to download the audio download at a later time in a location away from the event venue, e.g. outside the range of the transmitters 138.

When the audio download is being requested and received away from the event venue, the personal audio receiver 200 may not be connected to, e.g. paired with, the user interface device 216. Hence, it may be desirable for a distinct, e.g. dedicated, audio downloading device to be used, which allows the personal audio receiver 200 and/or the user interface device 216 to be easily connected to the audio downloading device to download the audio download.

In the arrangement of the disclosure depicted in FIG. 7, the audio downloading device 702 comprises a docking station configured to allow the personal audio receiver 200 and/or the user interface device 216 to be coupled to, e.g. docked in the audio downloading device 702. In some arrangements, the personal audio receiver 200 and/or the user interface device 216 may be communicatively coupled to the docking station by virtue of the docking of the personal audio receiver 200 and/or the user interface device 216 with the audio downloading device 702. Additionally or alternatively, the personal audio receiver 200 and/or the user interface device 216 may be configured to communicatively couple with the audio downloading device 702 using wireless communication, e.g. using the user interface communication module 214.

The docking station may be configured to provide electrical power to the personal audio receiver 200 and/or the user interface device 216 when the personal audio receiver 200 and/or the user interface device 216 is docked with the docking station, and hence, even when the personal audio receiver and/or the user interface device 216 is communicatively coupled with the docking station using wireless communication, it may be desirable for the personal audio receiver 200 and/or the user interface device 216 to be docked with the docking station.

As depicted in FIG. 7, the audio download system 700 may further comprise a display screen 704 associated with the audio downloading device 702. The display screen 704 may be coupled to the audio downloading device 702 via a video cable, such as an HDMI® cable, a Displayport® cable or any other cable configured to carry video information and/or user control signals. Alternatively, the audio downloading device 702 may be coupled to the display screen 704 using a wireless video connection configured to allow video data and/or user control signals to be communicated between the audio downloading device 702 and the display screen 704.

The audio downloading system 700 may further comprise a further user interface device 706. The further user interface device 706 may be associated with, e.g. communicatively coupled to, the audio downloading device 702 and/or the personal audio receiver 200. The further user interface device 706 may send user control signals to the audio downloading system 700 and/or personal audio receiver in order to control the download and playback of audio downloads. In some arrangements, the further user interface device 706 may be coupled with the audio downloading device 702 and/or the personal audio receiver 200 via the display screen 704. In this arrangement, the user control signals may be transmitted to the audio downloading device 702 and/or the personal audio receiver 200 by virtue of the connection between the display screen 704 and the audio downloading device 702.

The audio downloading device 702 may be configured to present a Graphical User Interface (GUI) to the user, e.g. using the display screen 704. The GUI may provide the user with information on the audio downloads that are available to be downloaded, e.g. for which authorisation data is available on the personal audio receiver 200 and/or the audio downloading device 702. Additionally or alternatively, the GUI may be configured to provide the user with information on audio downloads that have already been downloaded and are available for playback. The user may select an audio download to be downloaded or played back using the further user interface device 706.

The audio downloads that are received by the audio downloading device 702 may be stored on a memory of the audio downloading device or a memory associated with the audio downloading device, such as a networked storage device or cloud storage device. For example, an audio download may initially be stored on the audio downloaded device 702, e.g. when it is first downloaded, and following a predetermined period of time, the audio download may be transferred or backed up on the networked or cloud storage device. If the user requests that an audio download stored on a networked or cloud storage device is played back, the audio download may be transferred back to the audio downloading device 702 to be played back. Alternatively, the audio download or the downloaded audio channels within the audio download may be streamed to the audio downloading device 702 to be played back, e.g. the audio download may not be transferred to the memory of the audio downloading device and may not be stored on the audio downloading device following playback of the audio download.

As shown in FIG. 7, the audio downloading system 700 may further comprise one or more first transducers 708 associated with the audio downloading device 702. When the user requests that an audio download is played back, the audio downloading device may playback the audio download using the first audio transducers 708.

As an alternative or in addition to playing back the audio download using the first transducers 708, the user may wish to listen to the audio download using one or more second transducers 710 associated with the personal audio receiver 200. The second transducers 710 may be the headphones 220 used to listen to the broadcast mixes 36 during the performance as described above. Alternatively, the second transducers 710 may be any other desirable audio transducers. When the user requests playback of the audio download, the audio downloading device 702 may transmit one or more downloaded audio channels from the audio download, e.g. to the personal audio receiver.

The signal transmitted by the audio downloading device 702 comprising the one or more downloaded audio channels from the audio download may be formatted in the same way as the transmission data stream transmitted by the transmitters 138 as described above.

The personal audio receiver 200 may receive and process the signal from the audio downloading device 702 in the same way as the wireless signals 46 received from the transmitters 138 during the event. As described above, the one or more downloaded audio channels may correspond to the broadcast mixes 36 received by the personal audio receiver 200 during the event, and the user may control the relative volume of each of the downloaded audio channels to create a personalised mix in the same way as with the audio signal received during the performance, as described above.

During the performance, the user content settings input by the user may have been stored. During playback of the downloaded audio channels, the personal audio receiver 200 may be configured to retrieve the stored user content settings and adjust the relative volumes of the downloaded audio channels according to the retrieved user content settings.

Alternatively, the user may provide the user content setting to the audio downloading device 702 using the further user interface device 706. The GUI may indicate the current user content setting to the user and may provide options for adjusting the user content setting using the further user interface device 706 as desired.

When the audio download is being played back by the audio downloading device 702, the audio downloading device 702 may adjust the relative volumes of each of the downloaded audio channels within the audio download in the same way as the personal audio receiver according to the user content setting before playing back the audio download.

In some arrangements, the personal audio receiver 200 may retrieve the stored user content settings and may send the retrieved user content setting to the audio downloading device 702. The audio downloading device may adjust the relative volumes of the downloaded audio channels according to the retrieved user content settings.

As described above, the audio downloading device 702 is configured to receive a transmission comprising the audio download. The audio downloading device may therefore be configured to establish a data connection with a data server on which the audio download is stored and made available for download. In the arrangement shown in FIG. 7, the audio downloading device comprises a first communication system 702a configured to establish the data connection. In some arrangements of the disclosure, the first communication system 702a may be a wireless communication system, such as a Wi-Fi® communication device. In other arrangements, the first communication system may be a wired communication system, such as an Ethernet communication system. The audio downloading device 702 may be configured to establish a two-way connection with the data server using the first communication system 702a.

As depicted in FIG. 7, the audio downloading device 702 may further comprise a second communication system 702b. The audio downloading device 702 may be configured to transmit the downloaded audio channels to the personal audio receiver 200 using the second communication system 702b. As mentioned above, the signals comprising the downloaded audio channels may be formatted in the same way as the wireless signals 46 transmitted by the transmitters 138 described above. Hence, the second communication system 702b may be configured to transmit the downloaded audio channels using a uni-directional broadcast transmission.

Although the invention has been described by way of example, with reference to one or more examples, it is not limited to the disclosed examples and other examples may be created without departing from the scope of the invention, as defined by the appended claims.

1. A method of authorising an audio download, the method comprising:
receiving, at a receiving device, a first wireless signal comprising authorisation data;
requesting an audio download using the authorisation data; and
receiving a transmission comprising the audio download.

2. The method of claim 1, wherein the first wireless signal further comprises one or more audio channels, wherein the audio download corresponds to one or more of the audio channels.

3. The method of claim 1 or 2, wherein the method further comprises:
receiving a second wireless signal comprising one or more audio channels, wherein the audio download corresponds to one or more of the audio channels.

4. The method of claim 3, wherein the first and second wireless signals are received at substantially the same location.

5. The method of claim 4, wherein the transmission comprises an associated download, the associated download corresponding to the authorisation data.

6. The method of any of the preceding claims, wherein the method further comprises:
transmitting the first wireless signal using a first transmitter remote from the receiving device, wherein the first wireless signal is transmitted over an area within which sound corresponding to the audio download is audible.

7. The method of any of claim 3 or any of claims 4 to 6 when depending on claim 3, wherein the method further comprises:
transmitting the second wireless signal using a second transmitter remote from the receiving device, wherein the second wireless signal is transmitted over an area within which sound corresponding to one or more of the audio channels is audible.

8. The method of claim 3 or any of claims 4 to 7 when depending on claim 3, wherein the first and/or second wireless signals are transmitted over an area within which sound corresponding to one or more of the audio channels is audible.

9. The method of any of the preceding claims, wherein the method further comprises:
coupling the receiving device to an audio downloading device, wherein the transmission comprising the audio download is received by the audio downloading device.

10. The method of claim 9 when depending on claim 2 or 3, wherein the method further comprises:
receiving at the receiving device and/or audio downloading device a user content setting; and
adjusting the relative volumes of one or more of the audio channels according to the user content setting.

11. The method of claim 10 wherein the method further comprises: storing the user content setting on the receiving device and/or audio downloading device.

12. The method of any of claims 9 to 11, wherein the method further comprises:
transferring the authorisation data from the receiving device to the audio downloading device, wherein the audio download is requested by the audio downloading device using the authorisation data.

13. The method of any of claims 8 to 12, wherein the method further comprising:
transmitting one or more downloaded audio channels from the audio download using the audio download device.

14. The method of claim 13, wherein the method further comprises:
receiving the one or more downloaded audio channels from the audio downloading device at the receiving device; and
playing back one or more of the downloaded audio channels using a first audio transducer associated with the receiving device.

15. The method of any of claims 10 to 13, wherein the method further comprises:
playing back one or more of the downloaded audio channels from the audio download using a second audio transducer associated with the audio downloading device.

16. The method of any of claims 10 to 15, wherein the method further comprises:
receiving at the receiving device and/or audio downloading device a user content setting; and
adjusting the relative volumes of one or more of the downloaded audio channels from the audio download according to the user content setting.

17. The method of any of claim 11 or any of claims 12 to 16 when depending on claim 11, wherein the method further comprises:
adjusting the relative volumes of one or more of the downloaded audio channels from the audio download according to the stored user content setting.

18. The method of claim 2 or 3, or any of claims 4 to 17 when depending on claim 2 or 3, wherein the method further comprises:
combining one or more of the audio channels into a combined audio channel.

19. The method of any of the preceding claims, wherein the first wireless signal is a unidirectional broadcast signal.

20. The method of claim 3 of any of claims 4 to 19 when depending on claim 3, wherein the second wireless signal is a unidirectional broadcast signal.

21. An audio system comprising:
a receiver configured to receive a wireless signal comprising authorisation data; and
a downloader configured to:
request a download comprising audio data, wherein the download is requested using the authorisation data; and
receive the download.

22. The audio system of claim 21, wherein the download further comprises an associated download, the associated download corresponding to the authorisation data.

23. The audio system of claim 21 or 22, wherein the wireless signal further comprises one or more audio channels, wherein the audio data corresponds to one or more of the audio channels.

24. The audio system of claim 21 or 22, wherein the receiver is configured to receive a further wireless signal comprising one or more audio channels, wherein the audio data corresponds to one or more of the audio channels.

25. The audio system of claim 23 or 24 wherein the receiver is further configured to playback one or more of the audio channels using a first audio transducer associated with the receiver.

26. The audio system of any of claims 23 to 25, wherein one or more of the audio channels are played back following a delay after the wireless signal has been received by the receiver.

27. The audio system of any of claims 23 to 26, wherein the receiver and/or downloader is configured to:
receive a user content setting; and
adjust the relative volumes of one or more of the audio channels according to the user content setting.

28. The audio system of any of claims 21 to 27, wherein the downloader is further configured to playback one or more of the audio channels provided within the audio data using a second audio transducer associated with the downloader.

29. The audio system of any of claims 21 to 28, wherein the downloader is further configured to broadcast a further wireless signal comprising one or more of the audio channels provided within the audio data.

30. The audio system of any of claims 21 to 29, wherein the downloader is further configured to:
receive a user setting; and
adjust the relative volumes of one or more of the audio channels according to the user setting.

31. An audio broadcast system configured to broadcast an audio signal within a venue, the system comprising:
an audio distribution box configured to receive a plurality of audio input channels and distribute the audio input channels to a stage audio mixer and a plurality of Analogue to Digital Convertors (ADCs) and/or preamplifiers;
the plurality of ADCs and/or preamplifiers being configured to generate a plurality of digital audio signals based on the audio channel inputs;
a digital audio work station configured to combine one or more of the digital audio signals to generate two or more audio mixes;
a multiplexer configured to generate a multiplexed signal comprising the two or more audio mixes;
a first transmitter configured to broadcast the multiplexed signal within the venue.

32. The system of claim 31, wherein the digital audio work station comprises a time source, wherein the transmission of audio signals between the plurality of ADCs and/or preamplifiers, the digital audio work station and the multiplexer is synchronised according to the time source.

33. The system of claim 31 or 32, wherein the multiplexer is configured to generate a timing signal according to the time source.

34. The system according to claim 33, wherein multiplexer is configured to provide the timing signal to the first transmitter.

35. The system according to claim 33 or 34, wherein timing of a transmission of audio signals by the transmitter is performed according to the timing signal.

36. The system according to any of claims, 31 to 35, wherein the system further comprises a second transmitter, the second transmitter being coupled to the first transmitter and configured to broadcast the multiplexed signal within the venue.

37. The system according to claim 36, wherein the first transmitter is configured to provide the timing signal to the second transmitter, and wherein the timing of a transmission of audio signals by the second transmitter is performed according to the timing signal.

38. The system according to any of claims 31 to 37, wherein the multiplexer is configured to receive authorisation data corresponding to one or more of the audio mixes, wherein the multiplexed signal comprises the authorisation data.

39. An audio system or audio broadcast system substantially as described herein, with reference to and as shown in the drawings.

40. A method of authorising an audio download substantially as described herein and with reference to the drawings.
